(19) United States
(12) Patent Application Publication
(10) Pub. No.: US 2009/0226007 A1
(43) Pub. Date: Sep. 10, 2009

(54) MUTE CIRCUIT

(75) Inventor: Yoshikazu Nagashima, Yokohama-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/400,818

(22) Filed: Mar. 10, 2009

(30) Foreign Application Priority Data
Mar. 10, 2008 (JP) 2008-060028

(51) Int. Cl. H04B 15/00

(52) U.S. Cl. 381/94.5

(57) ABSTRACT

A mute circuit has a resistor net configured to include a plurality of resistors connected in cascade between two reference voltage terminals, the resistor net being capable of outputting one of divided voltages from between the adjacent resistors, a selecting circuit configured to control selection of the divided voltage outputted from the resistor net based on logic of a selecting signal, a signal propagation determining circuit configured to monitor a voltage level of the divided voltage selected by the selecting circuit using an alternating test signal, and determine whether a signal indicating the monitored result propagates or not at the same cycle as that of the test signal, a memory circuit configured to store data corresponding to an output signal of the signal propagation determining circuit in association with the selecting signal, a first switching circuit configured to switch whether a DC blocking capacitor is charged or not according to the divided voltage outputted from between specific resistors in the resistor net, a second switching circuit configured to switch whether different reference voltages or the same reference voltages is applied to the two reference voltage terminals, and a switch controlling circuit configured to shut off a charge path to the DC blocking capacitor until a result of determination by the signal propagation determining circuit is obtained, select the divided voltage by the selecting circuit based on the data stored in the memory circuit and charge the DC blocking capacitor by switching the first switching circuit after the result of determination by the signal propagation determining circuit has been obtained, and stop charging the DC blocking capacitor by switching the first switching circuit after the output signal of the signal propagation determining circuit becomes steady.

### CROSS REFERENCE TO RELATED APPLICATIONS

This application is based upon and claims the benefit of priority from the prior Japanese Patent Application No. 2008-60028 filed on Mar. 10, 2008, the entire contents of which are incorporated herein by reference.

### BACKGROUND OF THE INVENTION

1. Field of the Invention

The present invention relates to a mute circuit which can, in a case where an audio signal is outputted through a headphone, etc., prevent a pop noise that can be generated at a time of power activation.

2. Related Art

With respect to a headphone, a DC blocking capacitor is often connected in series for the purpose of removing direct current components from an audio signal. In order to prevent a pop noise at a time of power activation, it is necessary, prior to playback of the audio signal, that an electric potential of the DC blocking capacitor is charged up to the midpoint of the power supply voltage. With respect to a mute circuit which can prevent such pop noise, various kinds of circuit configurations have been proposed (e.g. JP-A (Kokai) No. 11-346124, IP-A (Kokai) No. 2005-217613).

JP-A (Kokai) No. 11-346124 discloses a processing signal switching circuit which, at a time of power activation, supplies to the headphone a reference voltage when the reference voltage is smaller than a threshold voltage, and supplies to the headphone the original audio signal once the reference voltage becomes greater than or equal to the threshold voltage.

JP-A (Kokai) No. 2005-217613 discloses a pop noise preventing circuit which prevents the pop noise by controlling a voltage applied to the headphone at a time of power activation to change gradually.

However, in the case of JP-A (Kokai) No. 11-346124, separate resistor strings are required for reference voltage generation and threshold voltage generation, respectively. With such configuration, the circuit size of the processing signal switching circuit will become larger.

In the case of JP-A (Kokai) No. 2005-217613, since a charge curve is controlled in detail, the internal configuration of the pop noise preventing circuit will become complicated. Moreover, since this pop noise preventing circuit is connected prior to an amplifier, it is necessary to connect a capacitor to an input terminal of the pop noise preventing circuit in order to retain the reference voltage. This capacitor will require a size of several tens of micro farads (μF), making it difficult to reduce the circuit size of the pop noise preventing circuit.

### SUMMARY OF THE INVENTION

According to one aspect of the present invention, A mute circuit comprising:

a resistor net configured to include a plurality of resistors connected in cascade between two reference voltage terminals, the resistor net being capable of outputting one of divided voltages from between the adjacent resistors;

a selecting circuit configured to control selection of the divided voltage outputted from the resistor net based on logic of a selecting signal;

a signal propagation determining circuit configured to monitor a voltage level of the divided voltage selected by the selecting circuit using an alternating test signal, and determine whether a signal indicating the monitored result propagates or not at the same cycle as that of the test signal;

a memory circuit configured to store data corresponding to an output signal of the signal propagation determining circuit in association with the selecting signal;

a first switching circuit configured to switch whether a DC blocking capacitor is charged or not according to the divided voltage outputted from between specific resistors in the resistor net;

a second switching circuit configured to switch whether different reference voltages or the same reference voltages is applied to the two reference voltage terminals; and

a switch controlling circuit configured to shut off a charge path to the DC blocking capacitor until a result of determination by the signal propagation determining circuit is obtained, select the divided voltage by the selecting circuit based on the data stored in the memory circuit and charge the DC blocking capacitor by switching the first switching circuit after the result of determination by the signal propagation determining circuit has been obtained, and stop charging the DC blocking capacitor by switching the first switching circuit after the output signal of the signal propagation determining circuit becomes steady.

### BRIEF DESCRIPTION OF THE DRAWINGS

FIG. 1 is a block diagram showing a schematic configuration of a mute circuit according to a first embodiment of the present invention;

FIG. 2 is a circuit configuration showing one example of an internal configuration of a signal propagation determining circuit 7;

FIG. 3(A) is a graph showing an input characteristic of the signal propagation determining circuit 7;

FIG. 3(B) is a graph showing an output characteristic of the signal propagation determining circuit 7;

FIG. 4 is a timing chart showing operation timing of the signal propagation determining circuit 7 and a memory circuit 8;

FIG. 5 is block diagram showing one example of an internal configuration of the memory circuit 8;

FIG. 6 is a block diagram showing one example of an internal configuration of a decoding circuit 9;

FIG. 7 is a voltage waveform diagram showing changes in voltage levels of voltages Vc and Vref at the charging period;

FIG. 8 is a block diagram showing one example of an internal configuration of a CSTOP circuit 10;

FIG. 9 is a block diagram showing a schematic configuration of a mute circuit according to a second embodiment of the present invention;

FIG. 10 is a block diagram showing one example of an internal configuration of a charge controlling circuit 42;

FIG. 11 is a timing chart showing operation timing of the mute circuit;

FIG. 12 is a diagram showing explaining an outline performing a mute operation at the time of switching music playbacks;

FIG. 13 is a block diagram showing a schematic configuration of a mute circuit according to a third embodiment of the present invention;

FIG. 14 is a circuit configuration showing one example of an internal configuration of a DETMODE circuit 51;

FIG. 15 is a block diagram showing one example of an internal configuration of a MEMSEL circuit 52;

FIG. 16 is a circuit configuration showing one example of an internal configuration of a CSTOPH circuit 54;

FIG. 17 is a circuit configuration showing one example of an internal configuration of a CSTOPL circuit 55;

FIG. 18 is a timing chart showing operation timing in a case where a voltage Vc of a DC blocking capacitor C at one end side thereof is less than a voltage Vcx; and

FIG. 19 is a timing chart showing operation timing in a case where the voltage Vc of the DC blocking capacitor C at one end side thereof is greater than the voltage Vcx.

### DETAILED DESCRIPTION OF THE INVENTION

Referring now to the drawings, embodiments of the present invention will be described.

### First Embodiment

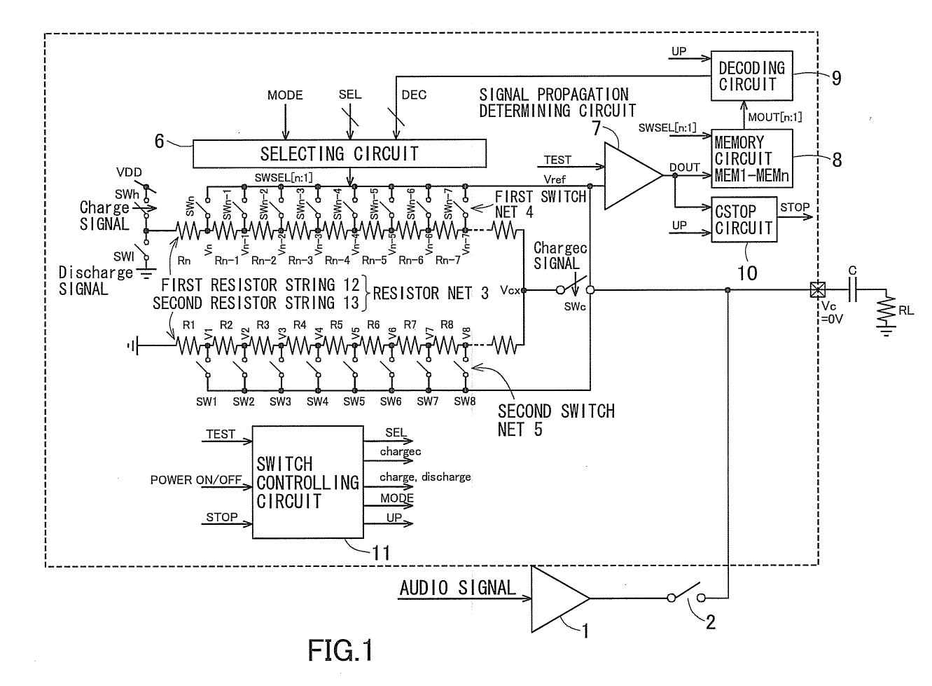

FIG. 1 is a block diagram showing a schematic configuration of a mute circuit according to a first embodiment of the present invention. The mute circuit shown in FIG. 1 is connected between an audio output switching circuit 2 and a DC blocking capacitor C. The audio output switching circuit 2 is connected to the subsequent stage of an amplifier 1 that amplifies an audio signal. An audio outputting device RL, which may be a headphone, etc., is connected to the other end side of the DC blocking capacitor C.

The mute circuit shown in FIG. 1 includes a resistor net 3, first and second switch nets 4 and 5, a selecting circuit 6, a signal propagation determining circuit 7, a memory circuit 8, a decoding circuit 9, a first switching circuit SWc, second switching circuits SWh and SWl, a CSTOP circuit 10 (charge stop signal generator), and a switch controlling circuit 11.

The resistor net 3 has a plurality of resistors connected in series. The first and the second switch nets 4 and 5 switch to select or not select each of divided voltages between the adjacent resistors in the resistor net 3. The selecting circuit 6 turns on or off the first and the second switch nets 4 and 5 based on the logic of a selecting signal (SEL signal) in order to select one divided voltage. The signal propagation determining circuit 7 monitors the voltage level of the divided voltage selected by the first and the second switch nets 4 and 5 using an alternating TEST signal, and determines whether a signal indicating a monitored result that has the same cycle as the TEST signal propagates or not. The memory circuit 8 stores data corresponding to an output signal of the signal propagation determining circuit 7 by associating the data with the selecting signal. The decoding circuit 9 generates, based on the data stored in the memory circuit 8, a decoding signal (DEC signal). Based on the decoding signal, the selecting circuit 6 selects the divided voltage. The first switching circuit SWc switches whether or not to charge the DC blocking capacitor C according to the divided voltage outputted from between specific resistors in the resistor net 3. The second switching circuits SWh and SWl control the switching of supplying one end side of the resistor net 3 with a reference voltage or ground voltage. The CSTOP circuit 10 (charge stop signal generator) controls charge suspension of the DC blocking capacitor C. The switch controlling circuit 11 controls the switching of the first and the second switching circuits SWc, SWh and SWl.

As will be described in more detail later on, so that the charge of the DC blocking capacitor C is not begun until the result determined by the signal propagation determining circuit 7 is obtained, the switch controlling circuit 11 controls the switching of the first switching circuit SWc to shut off a charge path to the DC blocking capacitor C, and supplies the selecting circuit 6 with selecting signals with different logics. As a result, divided voltages different from each other are outputted from the resistor net 3 in sequence. After the result determined by the signal propagation determining circuit 7 has been obtained, the switch controlling circuit 11 controls the switching of the first switching circuit SWc so that the DC blocking capacitor C is charged, and supplies the selecting circuit 6 with the decoding signal. And then the switch controlling circuit 11 stands by until the output signal of the signal propagation determining circuit 7 becomes a steady state. At the steady state, the switch controlling circuit 11 controls the switching of the first switching circuit SWc in order to stop charging the DC blocking capacitor C.

One end side of the resistor net 3 can be set to a power supply voltage or a ground voltage by the second switching circuits SWh and SWl, and the other end side of the resistor net 3 is grounded. The resistor net 3 includes first and second resistor strings 12 and 13 which are connected in series. One end of the first switching circuit SWc is connected to a connection node between these resistor strings.

The first resistor string 12 has a plurality of resistors which are connected in series, and the first switch net 4 is connected among these resistors. The second resistor string 13 has a plurality of resistors which are connected in series, and the second switch net 5 is connected among these resistors. The first switch net 4 has a plurality of switches that switch to select or not select each of divided voltages between the adjacent resistors in the resistor net 3. Likewise, the second switch net 5 has a plurality of switches in like manner. According to the logic of the SEL signal or the DEC signal inputted to the selecting circuit 6, only one of the switches among the switches in the first and the second switch nets 4 and 5 is turned on to select a divided voltage, and the selected divided voltage Vref is supplied to the signal propagation determining circuit 7.

When the switch SWh in the second switching circuit SWh and SWl is turned on and the switch SWl in the second switching circuit SWh and SWl is turned off, a power supply voltage VDD is applied to one end side of the resistor net 3. Thereby, a voltage Vcx at the connection node between the first and the second resistor strings 12 and 13 becomes as “Vcx=VDD/2”.

In this state, when the first switching circuit SWc is turned on and if a potential difference Vc between both ends of the DC blocking capacitor C is less than the voltage Vcx, the DC blocking capacitor C is charged. On the other hand, if the potential difference Vc is greater than or equal to the voltage Vcx at this point, the DC blocking capacitor C is discharged. At a time of power activation, the DC blocking capacitor C is charged when the first switching circuit SWc is turned on, since the DC blocking capacitor C does not have the accumulated electric charges at this point.

In a case where audio playback is stopped, prior to shutting off the power supply, the switch SWh in the second switching circuit SWh and SWl is turned off and the switch SWl in the second switching circuit SWh and SWl is turned on. Thereby, the DC blocking capacitor C is discharged.

The selecting circuit 6 selects the SEL signal or the DEC signal according to the logic of a MODE signal, and controls the switching of the first and the second switch nets 4 and 5 based on the selected SEL signal or DEC signal in order to select one divided voltage.

When the MODE signal is Low and a data value of the SEL signal is “i”, the i-th bit, i.e. SWSEL [i], among the bits of the output signal of the selecting circuit 6 becomes High while the rest of the bits become Low. On the other hand, when the MODE signal is High and a data value of the DEC signal is “j”, the j-th bit, i.e. SWSEL [j], among the bits of the output signal of the selecting circuit 6 becomes High while the rest of the bits become Low. In this way, among the bits of the output signal SWSEL [n:1] of the selecting circuit 6, only one bit becomes High, and the switch corresponding to the bit that has become High is turned on to select a specific divided voltage.

The switch controlling circuit 11 counts the number of pulses of the TEST signal and controls, based on the count result; timing of turning on the first switching circuit SWc, timing of switching the logic of the MODE signal to be inputted to the selecting circuit 6, and the logic of the SEL signal. While the signal propagation determining circuit 7 carries out the signal propagation determining process, the switch controlling circuit 11 sets the MODE signal Low, and switch the logics of the SEL signal in sequence. When the counted number of the pulses of the TEST signal reaches a predetermined value, the switch controlling circuit 11 determines that the signal propagation determining process has been completed, and thus sets the MODE signal High. Here, the TEST signal is inputted from the outside of the mute circuit.

With the mute circuit shown in FIG. 1, each time the power is supplied, the signal propagation determining process by the signal propagation determining circuit 7 is carried out prior to starting the audio playback. Based on the result of the signal propagation determining process, initial charging of the DC blocking capacitor C is performed. Then the audio playback is performed after the charging is completed. The result of the signal propagation determination can vary due to changes in the power supply voltage, the ambient temperature, etc. For such reason, therefore, the signal propagation determining process is carried out every time the power is supplied in order to acquire a signal propagation determination result that meets the actual operating environment. By performing the initial charging of the DC blocking capacitor C based on the result of the signal propagation determining process at each time, it is possible to set the voltage at one end side of the capacitor to be at the voltage Vcx at all times.

In this way, by performing the initial charging of the DC blocking capacitor C prior to carrying out the audio playback, it is possible to prevent a pop noise from being generated at the time of power activation.

Details of the signal propagation determining process will be described in the following. In carrying out the signal propagation determining process, it is set such that the switch SWh is turned on, the switch SWl is turned off, the first switching circuit SWc is turned off, and the MODE signal is Low. The switch controlling circuit 11 switches the logics of the SEL signal in sequence in synchronization with the TEST signal. Thereby, the selecting circuit 6 switches the first and the second switch nets 4 and 5 in sequence, and thus, different divided voltages are supplied to the signal propagation determining circuit 7 from the resistor net 3 in sequence.

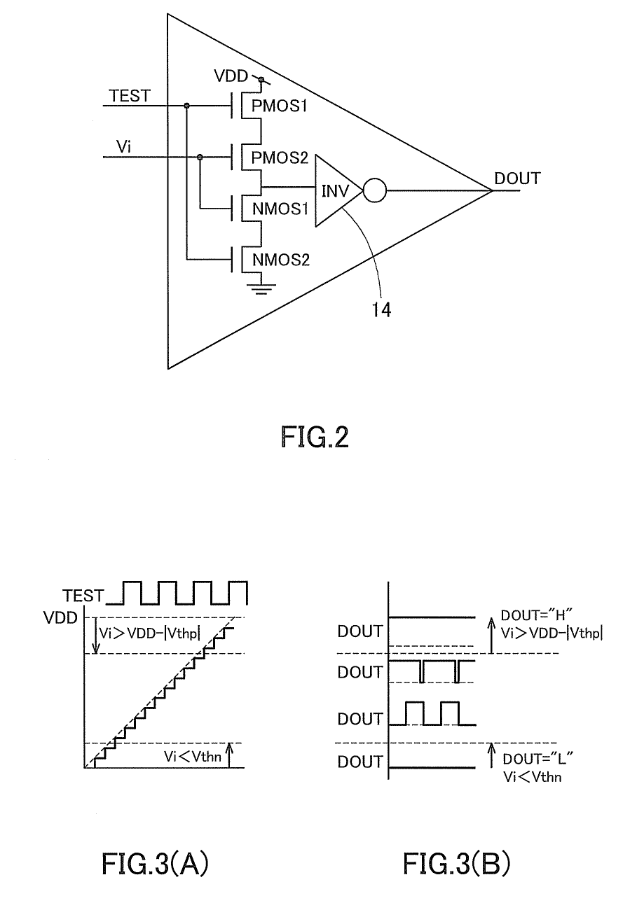

FIG. 2 is a circuit configuration showing one example of an internal configuration of the signal propagation determining circuit 7. FIG. 3(A) is a graph showing an input characteristic of the signal propagation determining circuit 7. FIG. 3(B) is a graph showing an output characteristic of the signal propagation determining circuit 7. The signal propagation determining circuit 7 shown in FIG. 2 has four transistors connected in a cascade between the power voltage VDD and the ground voltage. These four transistors are PMOS 1, PMOS 2, NMOS 1 and NMOS 2. The signal propagation determining circuit 7 also has an inverter 14 which inverts a voltage at a connection node between the PMOS 2 and the NMOS 1.

A voltage Vi to be applied to gates of the PMOS 2 and NMOS 1 is the divided voltage Vref selected at the resistor net 3. The TEST signal, as shown in FIG. 3(A), is a pulse signal of which logic changes at a constant cycle. The voltage Vi, as shown in FIG. 3(A), has a voltage level that changes in a stepwise manner.

When the voltage Vi is less than a threshold voltage Vthn of the NMOS 1, the NMOS 1 is at an off state. Thereby, the logic of an input signal of the inverter 14 becomes High, and a DOUT signal outputted from the signal propagation determining circuit 7 becomes Low.

In the case the voltage Vi is greater than or equal to the threshold voltage Vthn of the NMOS 1 and less than or equal to a threshold voltage Vthp of the PMOS 2, when the TEST signal is High at this point, the NMOS 1 and the NMOS 2 turn on and the input signal of the inverter 14 becomes Low (i.e. the DOUT signal becomes High). On the other hand, when the TEST signal is Low, the PMOS 1 and the PMOS 2 turn on and the input signal of the inverter 14 becomes High (i.e. the DOUT signal becomes Low). However, as the voltage Vi becomes higher, it becomes more difficult for the PMOS 2 to turn on, and thus, a period of time in which the DOUT signal holds Low becomes shorter.

When the voltage Vi becomes greater than the threshold voltage Vthp of the PMOS 2, the PMOS 2 becomes an off state. Thereby, the logic of the input signal of the inverter 14 becomes Low, and the DOUT signal becomes High.

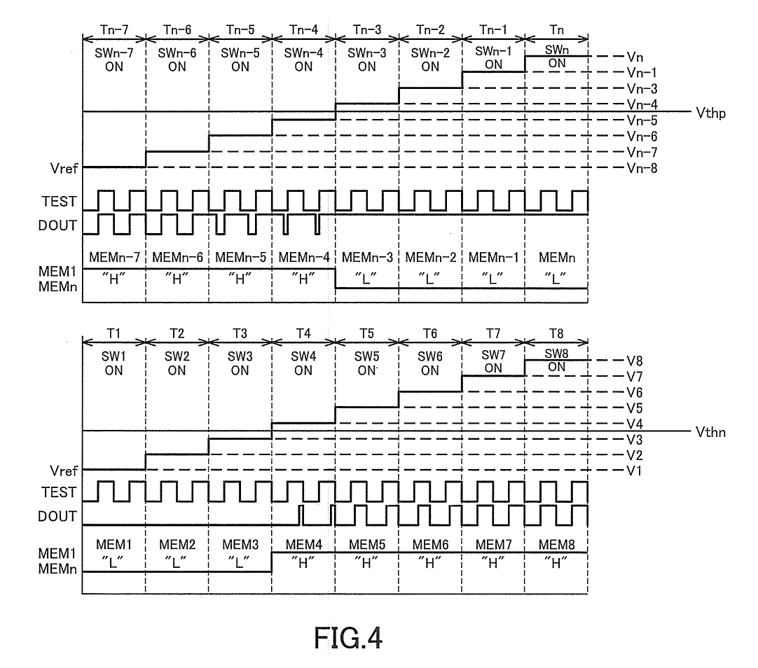

FIG. 4 is a timing chart showing operation timing of the signal propagation determining circuit 7 and the memory circuit 8. For example, if a switch SW1 in the first switch net 4 is turned on (period T1), a divided voltage V1 at the lowest level is supplied to the signal propagation determining circuit 7. At this time, since the NMOS 1 inside the signal propagation determining circuit 7 turns off, the input signal of the inverter 14 becomes High, and the DOUT signal becomes Low.

Then, as the switches in the first switch net 4 are switched in sequence and when a switch SW4 is turned on (period T4), a divided voltage V4 becomes greater than the threshold voltage Vthn of the NMOS 1, in order to turn on the NMOS 1. Thereby, pulses at High stage appear in the DOUT signal. The pulse width becomes wider as the voltage level of the divided voltage becomes higher (period T4 to period Tn-4).

Then, as the switches in the first switch net 4 are switched in sequence and when a switch SWn-3 is turned on (period Tn-3), a divided voltage Vn-3 becomes greater than the threshold voltage Vthp of the PMOS 2, in order to turn off the PMOS 2. Thereby, the input signal of the inverter 14 becomes Low, and the DOUT signal becomes High.

The divided voltage Vi to be inputted to the signal propagation determining circuit 7 varies depending on a status of a power source at the time of power activation. Moreover, the DOUT signal of the signal propagation determining circuit 7 also varies according to the fluctuations in the threshold voltages of the PMOS and the NMOS due to a change in the ambient temperature, etc. Therefore, according to the present embodiment, the signal propagation determining process is carried out every time the power is supplied, and the charging of the DC blocking capacitor C is controlled based on the current DOUT signal.

The DOUT signal is stored in the memory circuit 8, in association with the SEL signal. More specifically, as shown in FIG. 4, switching periods where the DOUT signal takes a pulse form (i.e. where the DOUT signal alternates) are set as High periods whereas switch switching periods where the DOUT signal is fixed to a Low state or a High state are set as Low periods, and a single bit is allocated to each switch switching period. Thereby, a bit string with a total of n bits, “n” being the same as the total number of switches in the first and the second switch nets 4 and 5, is obtained. The memory circuit 8 stores a bit string MOUT [n:1] of n bits.

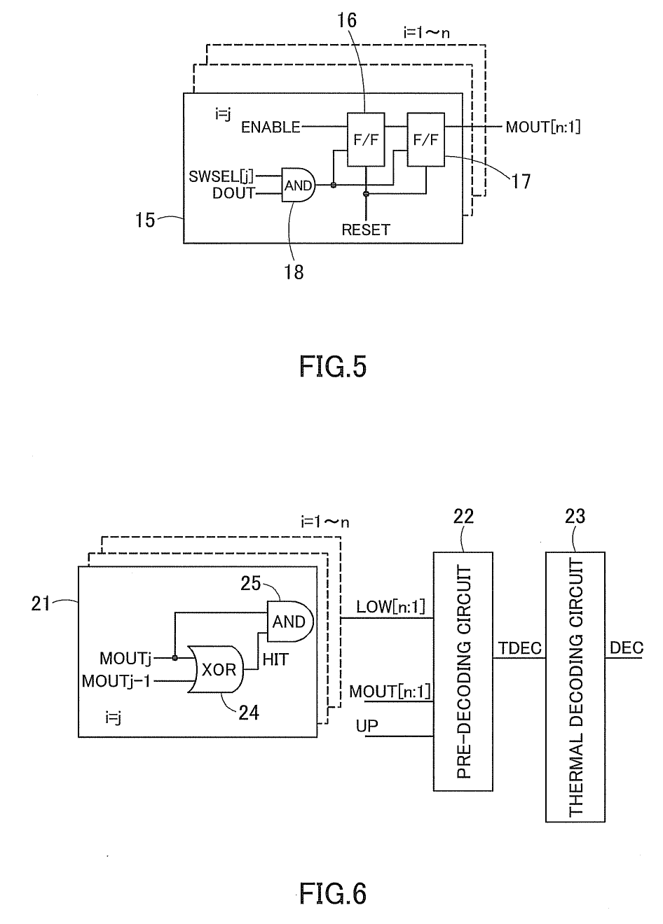

FIG. 5 is a block diagram showing one example of an internal configuration of the memory circuit 8. The memory circuit 8 shown in FIG. 5 has determiner 15 for each of n bits. Each of the bit determiners 15 has two flip-flops (hereinafter to be referred to as F/Fs) 16 and 17 which are connected in cascade, and an AND gate 18 which generates a clock signal for the respective F/Fs 16 and 17. The AND gate 18 calculates the logical product of one bit portion SWSEL [i] of the output signal of the selecting circuit 6 and the DOUT signal. An ENABLE signal is inputted to a D-input of the F/F 16. Thereby, when the DOUT signal shifts from Low to High within a selecting period of each switch, i.e. when the DOUT signal alternates, the F/Fs 16 and 17 output High. On the other hand, when the DOUT signal is fixed to a Low state or a High state, the F/Fs 16 and 17 output Low. Each of these F/Fs 16 and 17 is inputted to a RESET signal and initialized prior to the turning-on of the switch SWh.

In this case, the ENABLE signal may be a Charge signal for turning on the switch SWh or a signal fixed at a High level.

When the signal propagation determining process is completed, the decoding circuit 9 generates the DEC signal by reading out the data stored in the memory circuit 8. The decoding circuit 9 generates the decoding signal to select a single switch from among the switches in the first switch net 4 and the decoding signal to select a single switch from among the switches in the second switch net 5. Which of the decoding signals is outputted is determined based on the logic of an UP signal. For example, when the UP signal is Low, the decoding signal to select one switch from among the switches in the first switch net 4 is outputted, whereas when the UP signal is High, the decoding signal to select one switch from among the switches in the second switch net 5 is outputted. The UP signal, for instance, is generated at the switch controlling circuit 11.

FIG. 6 is a block diagram showing one example of an internal configuration of the decoding circuit 9. The decoding circuit 9 shown in FIG. 6 has decoders 21 for each of n bits, a pre-decoding circuit 22, and a thermal decoding circuit 23. Each of the decoders 21 has an XOR gate 24 for calculating the exclusive OR of the two adjacent bits in the data MOUT [n:1] stored in the memory circuit 8, and an AND gate 25 for calculating the logical product of an output signal of the XOR gate 24 and one of the input signals of the XOR gate 24.

When the two adjacent bits have different logics, the XOR gate 24 outputs High. The AND gate 25 outputs High when the specific bit within the memory circuit 8 is “1” and when the output from the XOR gate 24 is High. For example, the decoder 21 that corresponds to the switch SW4 in FIG. 4 outputs High. In this manner, each decoder 21 outputs a signal LOW [n:1].

The pre-decoding circuit 22 converts LOW [n:1] and MOUT [n:1] to a thermometer code. More specifically, when LOW [k] is High (“k” is a value within a range of 1 to n) and the UP signal is Low, all the bits in LOW [k−1:0] are set High. When the UP signal is High, the logical sum of a bit string where all the bits in LOW [k−1:0] are set High and MOUT [n:1] is calculated to generate the thermometer code.

In the above-described way, the memory circuit 8 stores the logic of the DOUT signal outputted from the signal propagation determining circuit 7 in association with SWSEL [n:1], which is the output of the selecting circuit 6. Moreover, the decoding circuit 9 outputs the DEC signal for selecting SWSEL [n:1] at the time when the DOUT signal becomes a specific value.

In FIG. 4, in the case of selecting the respective switches in the first and the second switch nets 4 and 5 in sequence, a pulse appears in the DOUT signal for the first time when the switch SW4 is selected. After then, the pulses appear in the DOUT signal continuously until a switch SWn-4 is selected.

Accordingly, the decoding circuit 9 according to the present embodiment outputs the DEC signal for selecting the switch SWn-3 from among the switches in the first switch net 4 and the DEC signal for selecting the switch SW4 from among the switches in the second switch net 5.

When the signal propagation determining process is completed, the switch controlling circuit 11 turns on the first switching circuit SWc and starts charging the DC blocking capacitor C. Furthermore, the switch controlling circuit 11 switches the logic of the MODE signal. Thereby, the selecting circuit 6 performs selecting operations of the first and the second switch nets 4 and 5 based on the DEC signal instead of the SEL signal.

As described above, there are two kinds of DEC signals, and it is possible to select either one of the two DEC signals to charge the DC blocking capacitor C. In the following, an example of charging the DC blocking capacitor C using the DEC signal for selecting the switch SWn-3 from among the switches in the first switch net 4 will be described. In this case, the selecting circuit 6 selects the switch SWn-3 based on the DEC signal. Thereby, through the switch SWn-3, the divided voltage is inputted to the signal propagation determining circuit 7 as a reference voltage Vref.

The voltage Vc at one end side of the DC blocking capacitor C decreases rapidly, right after the charging of the DC blocking capacitor C starts. Due to this, the reference voltage Vref to be inputted to the signal propagation determining circuit 7, in response to such decrease of the voltage Vc, also decreases to become less than the original divided voltage Vn-3.

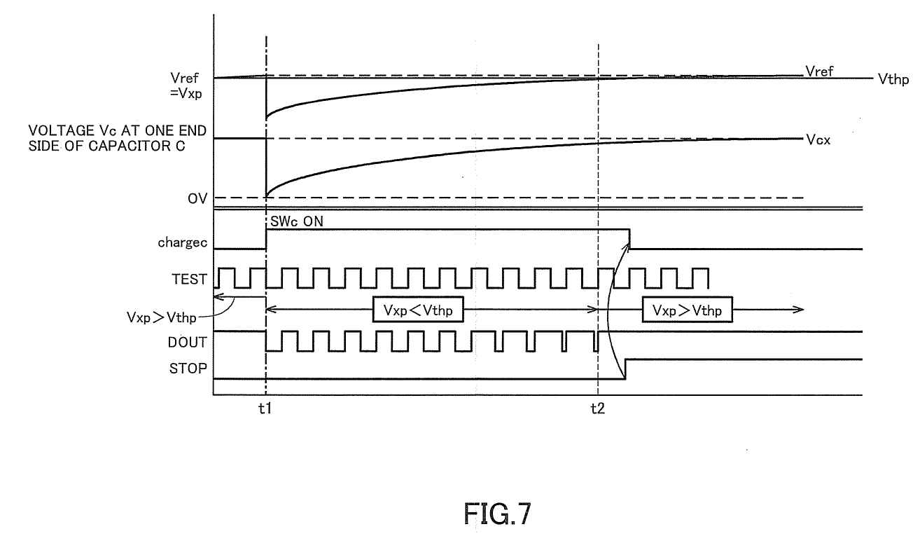

FIG. 7 is a voltage waveform diagram showing changes in voltage levels of the voltages Vc and Vref at the charging period. In a case where the charging of the DC blocking capacitor C starts at time t1 indicated in FIG. 7, the voltage levels of the voltages Vc and Vref both drop rapidly at that point, and from then on, the voltage levels of the voltages Vc and Vref rise gradually.

Then at time t2, the voltage Vref becomes the same as the threshold voltage Vthp of the PMOS 2, whereby the output signal DOUT of the signal propagation determining circuit 7 is fixed at a High level as in the case of period Tn-3 indicated in FIG. 4. Thereby, a STOP signal to be outputted from the CSTOP circuit 10 becomes High. This STOP signal is inputted to the switch controlling circuit 11, and then the switch controlling circuit 11 sets a Chargec signal Low. As a result, the first switching circuit SWc is turned off, and the charging of the DC blocking capacitor C is stopped.

Thus, in the above-described way, the initial charging of the DC blocking capacitor C is completed. After the completion of the initial charging, an audio playback process starts. At this point, since electric charges corresponding to the voltage “Vcx=VDD/2” is charged in the DC blocking capacitor C, there is no possibility that a pop noise is generated right after the audio playback process starts.

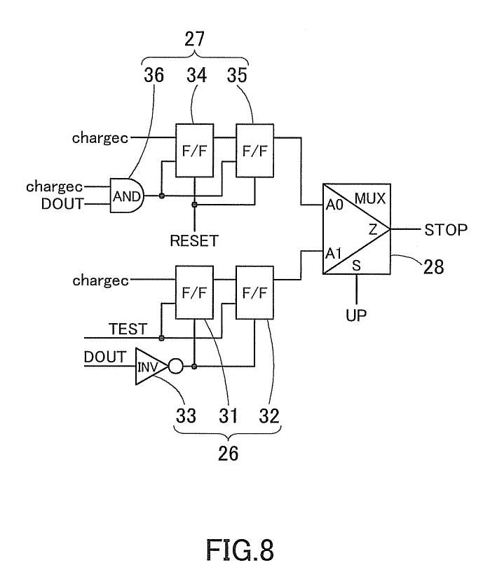

FIG. 8 is a block diagram showing one example of an internal configuration of the CSTOP circuit 10. The CSTOP circuit 10 shown in FIG. 8 has a first stop controller 26 for setting timing to stop charging in a case where a specific switch is selected from among the switches in the first switch net 4, a second stop controller 27 to set timing to stop charging in a case where a specific switch is selected from among the switches in the second switch net 5, and a multiplexer 28 which selects one of the output signal of the first and the second stop controllers 26 and 27 according to the logic of the UP signal and outputs the selected signal as the STOP signal.

The first stop controller 26 has two F/Fs 31 and 32 which are connected in cascade, and an inverter 33. The TEST signal is inputted to clock terminals of the F/Fs 31 and 32 thereof, while Chargec signal is inputted to D-input terminals of the F/Fs 31 and 32 thereof. Inverted DOUT signal is inputted to reset terminals of the F/Fs 31 and 32.

Thereby, in a case where the DOUT signal becomes Low, the first stop controller 26 resets the F/Fs 31 and 32, and sets the output of the F/F 32 High at a rising edge, of the TEST signal after the DOUT signal is fixed to a High state. (time t2 in FIG. 7).

The second stop controller 27 has two F/Fs 34 and 35 which are connected in cascade, and an AND gate 36. The output signal of the AND gate 36 is inputted to clock terminals of the F/Fs 34 and 35 thereof, while the RESET signal is inputted to reset terminals of the F/Fs 34 and 35 thereof to be reset.

The AND gate 36 calculates the logical product of the Chargec signal and the DOUT signal. Thereby, when the DOUT signal is alternating, the F/Fs 34 and 35 perform a clocking operation and an output of the F/F 35 becomes High. Explaining it with reference to FIG. 4, as the voltage Vref gradually rises and the DOUT signal starts a pulsing operation (period T4), the output of the F/F 35 becomes High, and thus the STOP signal becomes High.

In this way, according to the first embodiment, the voltage level of each of the individual divided voltages generated in the resistor net 3 is monitored using the alternating TEST signal, and the signal propagation determining circuit 7 determines whether the signal indicating the monitored result propagates or not. The memory circuit 8 stores the data for selecting the divided voltage at the maximum level where the signal stops propagating, and the data for selecting the divided voltage at the lowest level where the signal starts propagating. One of the data is selected to generate the divided voltage, and the charging of the DC blocking capacitor is started. Then, as the DOUT signal outputted from the signal propagation determining circuit 7 becomes a steady state, the charging of the DC blocking capacitor C is stopped. After then, the audio playback is started, and the voltage at one end side of the DC blocking capacitor C can be set to the midpoint voltage Vcx without being influenced by the changes in the power source, the ambient temperature, etc., thereby preventing a pop nose from being generated at the time of the audio playback.

In the above-described embodiment, the DC blocking capacitor C is charged in the state of having selected the switch SWn-3 from among the switches in the first switch net 4 after the signal propagation determining process has been completed. Instead of that, it is also possible to charge the DC blocking capacitor C in a state of having selected the switch SW4 from among the switches in the second switch net 5.

As another option, it is also possible that a single switch is always selected from among the switches in the first switch net 4 at the time of charging the DC blocking capacitor C. In this case, the second switch net 5 becomes unnecessary, thereby eliminating the second switch net 5. On the contrary, it is possible that a single switch is always selected from among the switches in the second switch net 5 at the time of charging the DC blocking capacitor C. In this case, the first switch net 4 can be eliminated. In this way, it is possible to eliminate one of the first and the second switch nets 4 and 5. In the case of eliminating one of the switch nets, the internal configurations of the selecting circuit 6 and the decoding circuit 9 can be simplified, whereby the whole circuit size of the mute circuit can be downsized.

### Second Embodiment

A second embodiment has a characteristic feature in which a fast-charge operation is performed in the initial charging of the DC blocking capacitor C at the time of power activation.

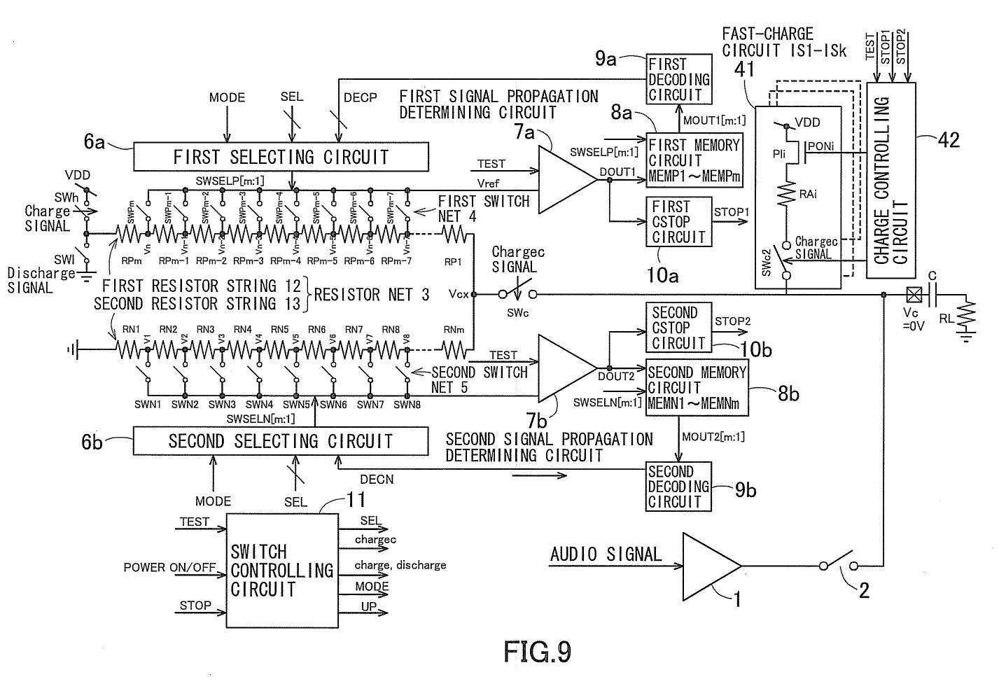

FIG. 9 is a block diagram showing a schematic configuration of a mute circuit according to the second embodiment of the present invention. As with the mute circuit shown in FIG. 1, the mute circuit shown in FIG. 9 includes the resistor net 3, the first and second switch net 4 and 5, the first switching circuit SWc, and the second switching circuit SWh and SWl. The resistor net 3 has the first and the second resistor strings 12 and 13. The first switch net 4 is provided corresponding to the first resistor string 12. The second switch net 5 is provided corresponding to the second resistor string 13.

Moreover, in association with to the first switch net 4, the mute circuit shown in FIG. 9 has a first selecting circuit 6a, a first signal propagation determining circuit 7a, a first memory circuit 8a, a first decoding circuit 9a, and a first CSTOP circuit (first signal propagation determiner) 10a. Likewise, in association with the second switch net 5, the mute circuit has a second selecting circuit 6b, a second signal propagation determining circuit 7b, a second memory circuit 8b, a second decoding circuit 9b, and a second CSTOP circuit (second signal propagation determiner) 10b.

In addition, the mute circuit shown in FIG. 9 has a fast-charge circuit 41 to accelerate the charging of the DC blocking capacitor C, and a charge controlling circuit 42 to control the fast-charge circuit 41.

In the first embodiment, the process of selecting the switches in the first switch net 4 in sequence to determine signal propagation, and the process of selecting the switches in the second switch net 5 in sequence to determine signal propagation are performed using a single signal propagation determining circuit 7. In the second embodiment, however, the process of selecting the switches in the first switch net 4 in sequence to determine signal propagation is performed using the first signal propagation determining circuit 7a, whereas the process of selecting the switches in the second switch net 5 in sequence to determine signal propagation is performed using the second signal propagation determining circuit 7b.

With respect to the first selecting circuit 6a, when the MODE signal is Low and a data value of the SEL signal is “i”, the i-th bit, i.e. SWSELP [i], among the bits of the output signal of the first selecting circuit 6a becomes High while the rest of the bits become Low. On the other hand, when the MODE signal is High and a data value of the DEC signal is “j”, the j-th bit, i.e. SWSELP [j], among the bits of the output signal of the first selecting circuit 6a becomes High while the rest of the bits become Low.

With respect to the second selecting circuit 6b, when the MODE signal is Low and a data value of the SEL signal is “i”, the i-th bit, i.e. SWSELN [i], among the bits of the output signal of the second selecting circuit 6b becomes High while the rest of the bits become Low. On the other hand, when the MODE signal is High and a data value of the DEC signal is “j”, the j-th bit, i.e. SWSELN [j], among the bits of the output signal of the second selecting circuit 6b becomes High while the rest of the bits become Low.

The first memory circuit 8a stores a signal propagation determination result derived by the first signal propagation determining circuit 7a. Based on the stored contents, the first decoding circuit 9a generates a DECP signal for selecting the first selecting circuit 6a. This DECP signal is a signal for selecting the switch SWn-3 in FIG. 4.

The second memory circuit 8b stores a signal propagation determination result derived by the second signal propagation determining circuit 7b. Based on the stored contents, the second decoding circuit 9b generates a DECN signal for selecting the second selecting circuit 6b. This DECN signal is a signal for selecting the switch SW4 in FIG. 4.

Internal configurations of the first and the second decoding circuits 9a and 9b are similar to that of the decoding circuit 9 as shown in FIG. 6. Since the first and the second decoding circuits 9a and 9b are provided corresponding with the first and the second switch nets 4 and 5, respectively, the pre-decoding circuits are unnecessary.

In this way, the mute circuit shown in FIG. 9 can perform the signal propagation determining process using the first switch net 4 and the signal propagation determining process using the second switch net 5 in parallel. Therefore, according to the second embodiment, it is possible to reduce the time necessary for the signal propagation determining processes by half, as compared to the case of the first embodiment, and thus, high-speed processing is possible.

The fast-charge circuit 41 has an arbitrary number k (“k” is an integer greater than or equal to 2) of charge accelerators 41a. Each of the charge accelerators 41a has a PMOS transistor Pli connected in cascade between the power source terminal VDD and one end of the DC blocking capacitor C, a resistor RAi, and a switch SWc2. The switch SWc2 turns on sometime after the first switching circuit SWc has turned on and the charging of the DC blocking capacitor C has started (at this switch timing, however, the DC blocking capacitor is in the midst of being charged). The reason that the timing at which the switch SWc2 turns on is delayed from the timing at which the first switching circuit SWc turns on is because there is a possibility that a pop noise is generated if charge acceleration is performed right after the charging of the DC blocking capacitor C has started.

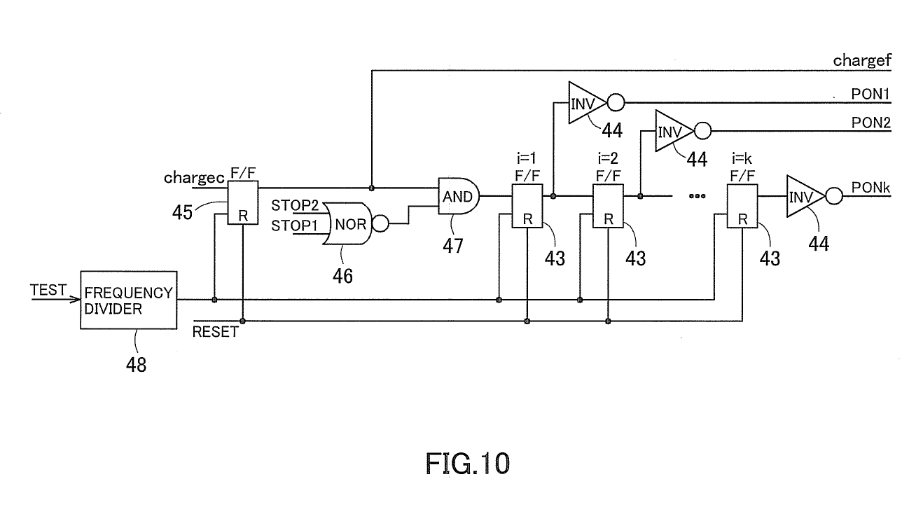

A gate voltage of the PMOS transistor Pli is controlled by the charge controlling circuit 42. FIG. 10 is a block diagram showing one example of an internal configuration of the charge controlling circuit 42. The charge controlling circuit 42 shown in FIG. 10 has a plurality of F/Fs 43, a plurality of inverters 44, F/F 45, a NOR gate 46, an AND gate 47, and a frequency divider 48. The F/Fs 43 are connected in cascade. Each of the inverters 44 inverts an output signal of each F/F 43. The F/F 45, the NOR gate 46 and the AND gate 47 generate a D-input signal of the F/F 43 arranged at the first stage. The frequency divider 48 generates the clock signal of the F/Fs 43.

The frequency divider 48, for instance, generates a signal with twice the cycle of the TEST signal. The F/F 45 latches the Chargec signal at a rising edge of an output signal of the frequency divider 48. While the DC blocking capacitor C is charged, the Chargec signal is High. Therefore, a Chargef signal outputted from the F/F 45 also becomes High. When both of STOP1 and STOP2 signals are Low, the NOR gate 46 outputs High. Accordingly, the AND gate 47 outputs a High level when both the STOP1 signal and the STOP2 signal are Low and while the DC blocking capacitor C is charged. At a point where the Chargef signal becomes High, the switch SWc2 is turned on, whereby the fast-charge operation starts.

Outputs of the plurality of F/Fs 43, which are connected in cascade, become High in sequence starting from the left, and outputs of the inverters 44 become Low in sequence. Thereby, the PMOS transistors Pli of the charge accelerators 41a within the fast-charge circuit 41 turn on in sequence, and a charging speed of the DC blocking capacitor C gradually accelerates.

When at least one of the STOP1 signal and the STOP2 signal becomes High, the output of the NOR gate 46 becomes Low, whereby the output of the F/F 43 at the first stage changes to Low. This signal logic is gradually transferred to the F/Fs 43 at the subsequent stages, whereby the PMOS transistors Pli turn off in sequence, and a charging speed of the DC blocking capacitor C gradually decelerates.

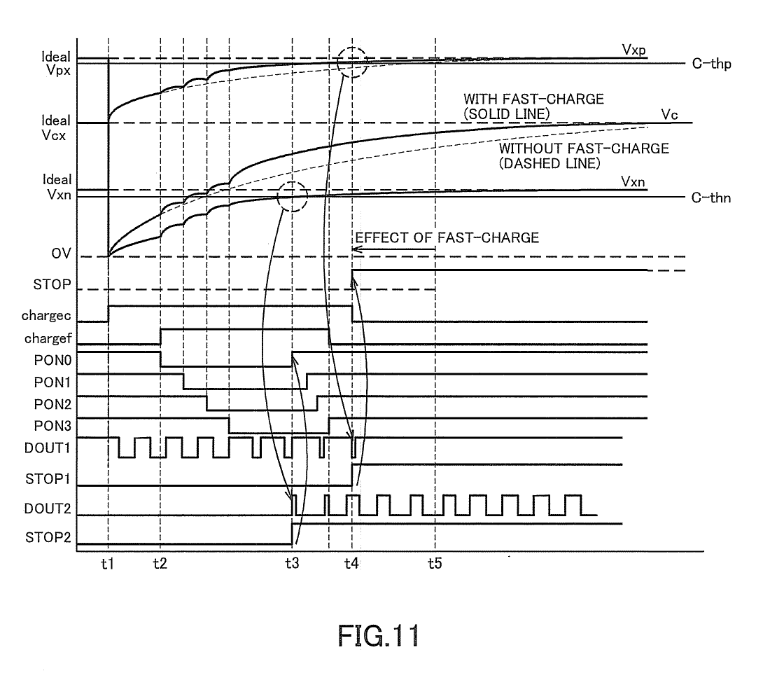

FIG. 11 is a timing chart showing operation timing of the mute circuit shown in FIG. 9. The charging of the DC blocking capacitor C starts at time t1. After that, at time t2, the Chargef signal becomes High, and the fast-charge operation starts. First, at time t2, an output PON 0 of the charge controlling circuit 42 becomes Low, and from then on, PON 1 to PON 3 gradually become Low. Thereby, the voltage Vcx at one end side of the DC blocking capacitor C rises rapidly in a stepwise manner.

After that, at time t3, the STOP2 signal becomes High, and the PON 0 signal is switched to High. From then on, the PON 1 to PON 3 are switched to High in sequence. Along with that, a degree of rise in the voltage level of the voltage Vcx gradually decreases.

After that, at time t4, the STOP1 signal also becomes High, the Chargec signal becomes Low, and the first switching circuit SWc is turned off. Thereby, the charging operation of the DC blocking capacitor C stops.

In this way, according to the second embodiment, the circuit for performing the signal propagation determining process using the first switch net 4 and the circuit for performing the signal propagation determining process using the second switch net 5 are provided separately, whereby both of the processes can be performed in parallel. Therefore, with the mute circuit according to the second embodiment, the time necessary for the signal propagation determining processes can be reduced to half the time necessary in the case of the first embodiment, and thus, high-speed processing is possible. Moreover, the fast-charge circuit 41 and the charge controlling circuit 42 are provided, and the fast-charge circuit 41 performs charge acceleration in the initial charging of the DC blocking capacitor C at the time of power activation. Because of this, fast charging can be made available. Accordingly, it is possible to reduce the time required from the power activation to the start of the audio playback (i.e. the mute period), whereby convenience for the users can be improved.

The fast-charge circuit 41 and the charge controlling circuit 42 as described above can be optionally connected to the mute circuit shown in FIG. 1. In this case, the charge controlling circuit 42 is applicable by adding a slight change in the internal configuration thereof.

### Third Embodiment

The first and the second embodiments are based on the premise of preventing a pop noise from being generated at the time of power activation. The present invention, as apparent from the following description of the third embodiment, is also applicable to a case of preventing a pop noise that can be generated in switching of musical numbers while music is played back.

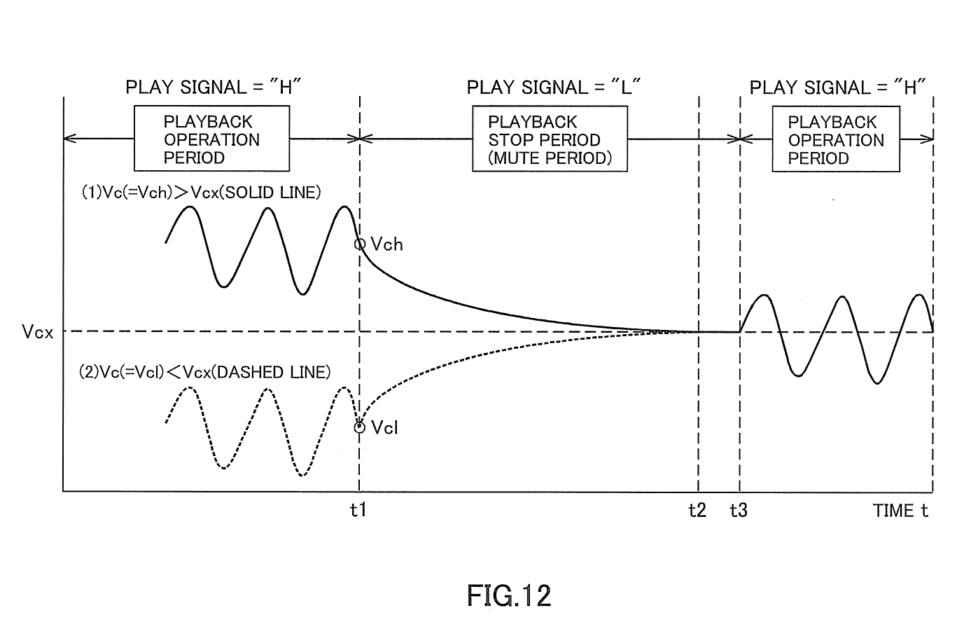

FIG. 12 is a diagram explaining an outline performing a mute operation at the time of switching music playbacks. When playback of a certain musical number ends at time t1 indicated in FIG. 12, a mute period (time t1 to time t2) is set prior to starting playback of the next musical number. During this mute period, the DC blocking capacitor C is charged/discharged so that the voltage Vc at one end side of the DC blocking capacitor C becomes the midpoint voltage Vcx. After that, at time t3, the next music playback is started.

As shown in FIG. 12, at the point of time t1, the voltage Vc at one end side of the DC blocking capacitor C can be a voltage Vch higher than the voltage Vcx, or the voltage Vc can be a voltage Vcl lower than the voltage Vcx. Under the condition “Vc=Vch (>Vcx)”, a discharging operation is performed during the mute period. Under the condition “Vc=Vcl (<Vcx)”, a charging operation is performed during the mute period. In either instance, the voltage Vc at one end side of the DC blocking capacitor C is set equal to the voltage Vcx by the time the mute period ends (at time t2).

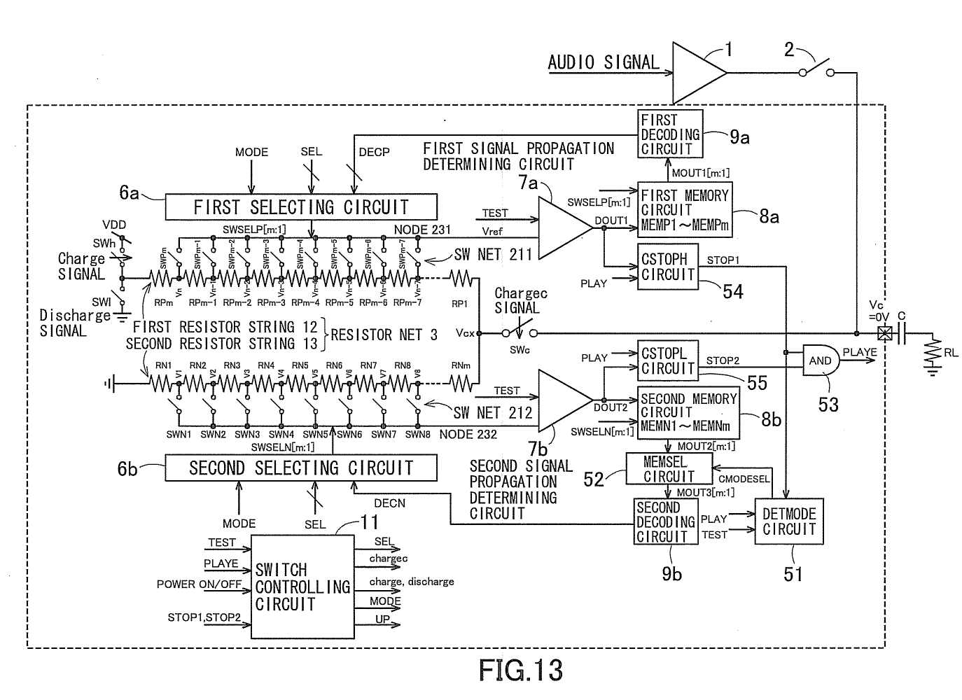

FIG. 13 is a block diagram showing a schematic configuration of a mute circuit according to the third embodiment of the present invention. In FIG. 13, the same reference numerals/characters are used in referring to configuration elements which are in common with the mute circuit shown in FIG. 9, and the description will be given mainly of differences between the mute circuits according to the second embodiment and the third embodiment.

As configuration elements that are not in the mute circuit shown in FIG. 9, the mute circuit shown in FIG. 13 has a DETMODE circuit 51, a MEMSEL circuit 52, and an AND gate 53. Moreover, instead of the first and the second CSTOP circuits 10a and 10b, the mute circuit shown in FIG. 13 has a CSTOPH circuit (first playback end voltage determining circuit) 54 and a CSTOPL circuit (second playback end voltage determining circuit) 55.

As in the case of the second embodiment, the mute circuit shown in FIG. 13 is configured on the premise that the signal propagation determining process is performed at the time of power activation, and the memory circuit 8 stores data to select a specific divided voltage in the resistor net 3. The data is also used at the time of switching of musical numbers.

At the time when one music playback ends, when the voltage Vc at one end side of the DC blocking capacitor C is the voltage Vch higher than the voltage Vcx, a DOUT1 signal outputted from the first signal propagation determining circuit 7a becomes High, and a STOP1 signal outputted from the CSTOPH circuit 54 becomes High. On the other hand, when the voltage Vc at one end side of the DC blocking capacitor C is the voltage Vcl lower than the voltage Vcx, the DOUT1 signal alternates, and the STOP1 signal becomes Low. In this way, according to the logic of the STOP1 signal, it is possible to determine whether the voltage Vc at one end side of the DC blocking capacitor C at the time when the music playback ends is higher or lower than the voltage Vcx.

The DETMODE circuit 51 generates a CMODESEL signal that holds the logic of the STOP1 signal for a predetermined period of time at the point of time when one music playback ends.

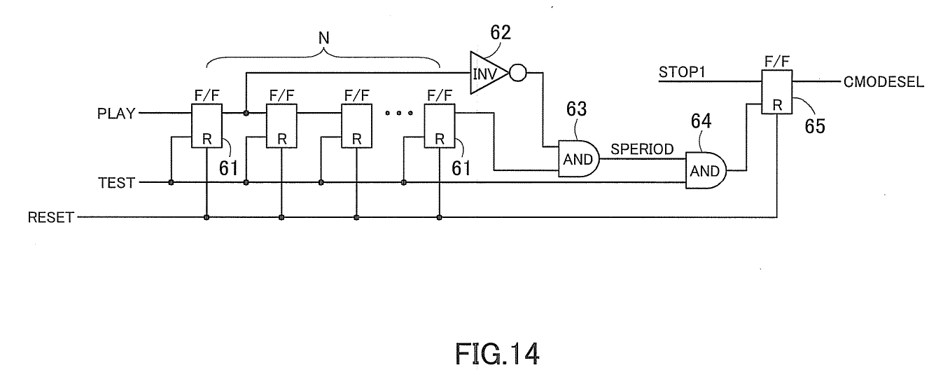

FIG. 14 is a circuit configuration showing one example of an internal configuration of the DETMODE circuit 51. The DETMODE circuit 51 shown in FIG. 14 has a plurality of F/Fs 61, an inverter 62, an AND gate 63, an AND gate 64, and an F/F 65. The F/Fs 61 are connected in cascade. The inverter 62 and the AND gate 63 generate a pulse signal with a pulse width corresponding to an interval between an output change point of the F/F 61 at the first stage and an output change point of the F/F 61 at the last stage. The AND gate 64 calculates the logical product of the output of the AND gate 63 and the TEST signal. The F/F 65 latches the STOP1 signal at the edge of the output of the AND gate 64.

According to the configuration of FIG. 14, the DETMODE circuit 51, after one music playback has ended, latches the STOP1 signal for a period corresponding to a predetermined number of clocks of the TEST signal. Thereby, the logic of the STOP1 signal at a predetermined period after one music playback is completed is latched eventually, and is outputted as the CMODESEL signal.

This CMODESEL signal is inputted to the MEMSEL circuit 52. The MEMSEL circuit 52 switches a voltage applied to the second decoder so that the divided voltage selected by the second selecting circuit 6b varies at charging period and discharging period of the DC blocking capacitor C. The reason that the divided voltage varies at charging period and discharging period is because otherwise the output of the second signal propagation determining circuit 7b does not change when the input voltage is within a predetermined voltage, and therefore, the second signal propagation determining circuit 7b cannot perform appropriate signal propagation determination.

In the present embodiment, at the time of discharging the DC blocking capacitor C, the MEMSEL circuit 52 revises the data stored in the memory circuit 8 so that the second selecting circuit 6b can select a divided voltage which is one step lower than the divided voltage selected for the charging. The MEMSEL circuit 52 outputs the revised data to the second decoder.

Explaining it with reference to FIG. 4, the second selecting circuit 6b selects the switch SW4 at charging whereas the second selecting circuit 6b selects the switch SW3 at discharging. Thereby, the output DOUT of the second signal propagation determining circuit 7b does not alternate but is fixed to a Low state.

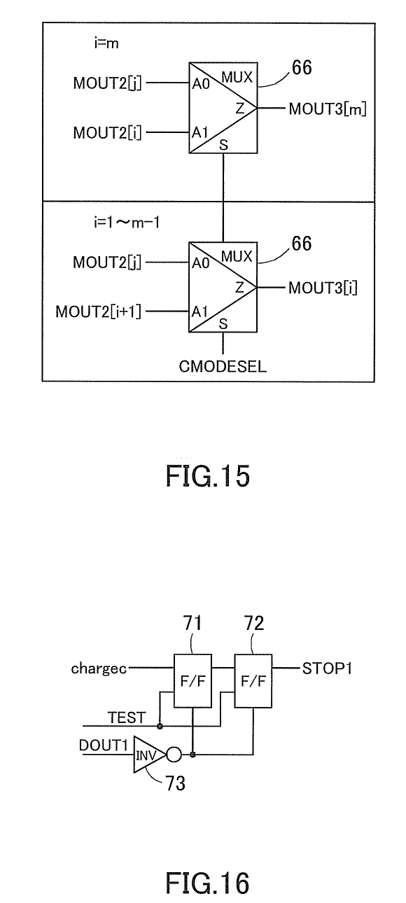

FIG. 15 is a block diagram showing one example of an internal configuration of the MEMSEL circuit 52. The MEMSEL circuit 52 shown in FIG. 15 has an arbitrary number m of multiplexers 66 provided corresponding to respective bits of a bit string MOUT 2 [m:1]. Each of these multiplexers 66 selects one of the two input signals according to the logic of the CMODESEL signal, and outputs the selected signal. The two input signals of the multiplexer 66 corresponding to the most significant bit are the same. Therefore, the multiplexer 66 outputs the same data regardless of the logic of the CMODESEL signal. With respect to the multiplexers 66 corresponding to the rest of the bits, the two input signals are MOUT 2 [i] and MOUT 2 [i+1]. When the CMODESEL signal is Low, MOUT 2 [i] is selected, and when the CMODESEL signal is High, MOUT 2 [i+1] is selected, in order to output the selected signal as MOUT 3 [i:1].

With the circuit configuration as shown in FIG. 15, the CMODESEL signal becomes Low if the DC blocking capacitor C is charged at the time when one music playback ends. Therefore, MOUT 3 [m:1] becomes equal to MOUT 2 [m:1]. On the other hand, the CMODESEL signal becomes High if the DC blocking capacitor C is discharged at the time when one music playback ends. Therefore, MOUT 3 [m:1] becomes equal to {MOUT 2 [m], MOUT 2 [m:2]}. Here, { } is a bit concatenation operator used in logic algebra.

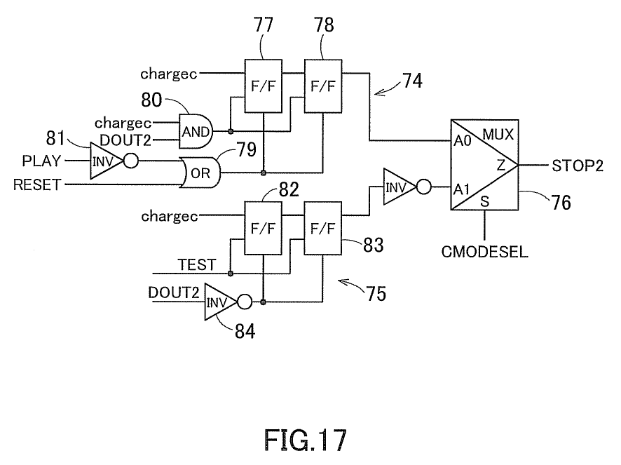

FIG. 16 is a circuit configuration showing one example of an internal configuration of the CSTOPH circuit 54. FIG. 17 is a circuit configuration showing one example of an internal configuration of the CSTOPL circuit 55.

The CSTOPH circuit 54 shown in FIG. 16 has two F/Fs 71 and 72 which are connected in cascade, and an inverter 73 which generates a reset signal of each of the F/Fs 71 and 72. These F/Fs 71 and 72 are in reset states while the output DOUT1 of the first signal propagation determining circuit 7a is Low. When the output DOUT1 is High, the F/Fs 71 and 72 latch the Chargec signal at a rising edge of the TEST signal. Since the Chargec signal becomes High at the time of charging the DC blocking capacitor C, the STOP1 signal becomes High at a rising edge of the TEST signal at the time of charging.

The CSTOPL circuit 55 shown in FIG. 17 has a first stop controller 74, a second stop controller 75, and a multiplexer 76. The first stop controller 74 performs stop-control in the case where the voltage Vc at one end side of the DC blocking capacitor C is less than or equal to the voltage Vcx. The second stop controller 75 performs stop-control in the case where the voltage Vc at one end side of the DC blocking capacitor C is greater than or equal to the voltage Vcx. The multiplexer 76 selects an output of the first stop controller 74 or the second stop controller 75.

The first stop controller 74 has two F/Fs 77 and 78 which are connected in cascade, an OR gate 79 which generates reset signal of the F/Fs 77 and 78, an AND gate 80 which generates clock signal of the F/Fs 77 and 78, and an inverter 81. The first stop controller 74, when a PLAY signal is High (i.e. while at playback of music), resets two of the F/Fs 77 and 78. When the PLAY signal is Low (i.e. while at playback suspension), the first stop controller 74 cancels the reset states of the two F/Fs 77 and 78. While at playback suspension, the F/F 78 outputs High at a point of time where both the Chargec signal and a DOUT2 signal become High, whereby the STOP2 signal becomes High.

The second stop controller 75 has two F/Fs 82 and 83 which are connected in cascade, and an inverter 84 which generates reset signal of the F/Fs 82 and 83. The F/Fs 81 and 82 are reset by the DOUT2 signal, and latch the Chargec signal at a rising edge of the TEST signal.

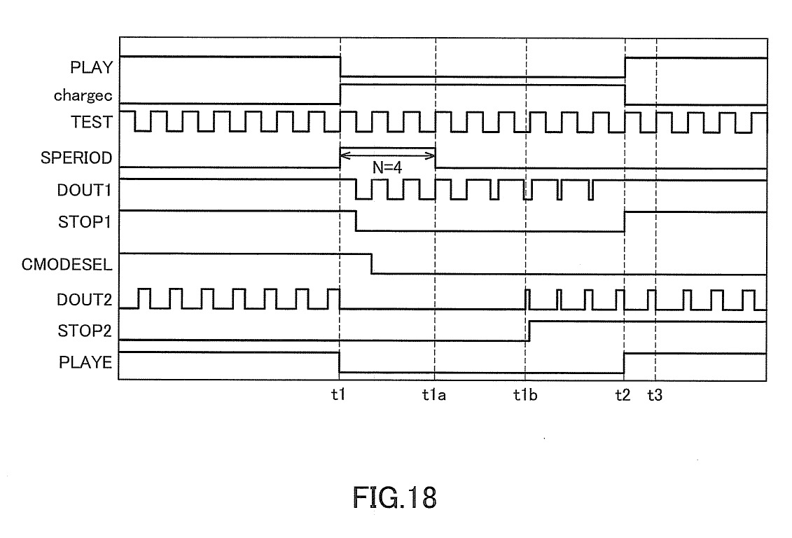

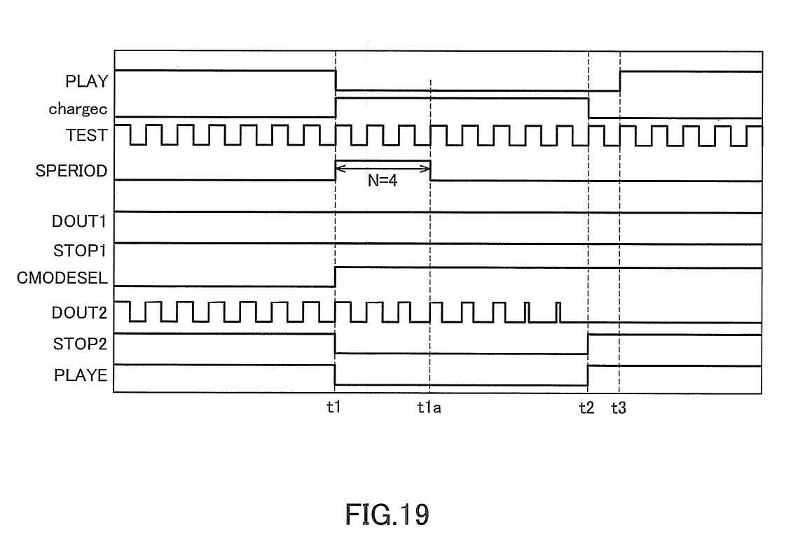

FIG. 18 is a timing chart showing operation timing in a case where the voltage Vc at one end side of the DC blocking capacitor C is less than the voltage Vcx. FIG. 19 is a timing chart showing operation timing in a case where the voltage Vc at one end side of the DC blocking capacitor C is greater than the voltage Vcx. If playback of one musical number ends at time t1 indicated in FIG. 18, the output DOUT1 alternates since the voltage Vc is less than the voltage Vcx. For a predetermined period of time after time t1, an output SPERIOD of the AND gate shown in FIG. 14 is High, and the CMODESEL signal is kept at a Low level at a rising edge of the TEST signal during the High period of the SPERIOD signal. Thereby, it is detected that the voltage Vc is less than the voltage Vcx.

In this way, at time t1a, the magnitude relation between the voltages Vc and Vcx is stored according to the logic of the CMODESEL signal. The reason that the magnitude relation between the voltages Vc and Vcx is stored at time t1a is because it is necessary to appropriately keep the magnitude relation between the voltages Vc and Vcx at the end of playback, considering that an electric potential of Vcx can change along with the passage of time due to the charging/discharging of the DC blocking capacitor C.

When the voltage Vc is less than the voltage Vcx, the DC blocking capacitor C is charged gradually, and along with that, the voltage Vc rises. Then, at time t1b, the output DOUT2 of the second signal propagation determining circuit 7b becomes High, while the output of the F/F 78 becomes High and the STOP2 signal also becomes High.

After that, at time t2, the STOP1 signal also becomes High, and a PLAYE signal outputted from the AND gate 53 shown in FIG. 13 becomes High. Thereby, the switch controlling circuit 11 sets the Chargec signal Low, and the first switching circuit SWc is turned off. Thus, the charging of the DC blocking capacitor C is completed. Moreover, the PLAY signal becomes High, and playback of the next musical number starts.

On the other hand, if the voltage Vc is greater than the voltage Vcx at the time when the playback of one musical number is stopped, the CMODESEL signal is kept at a High level at a rising edge of the TEST signal right before the SPERIOD signal is switched from High to Low. Thereby, it is detected that the voltage Vc is greater than the voltage Vcx.

When the voltage Vc is greater than the voltage Vcx, accumulated charges in the DC blocking capacitor C is gradually discharged through the second resistor string 13. Along with that, the voltage Vc decreases, and a pulse width of the DOUT2 signal gradually becomes smaller, and eventually the DOUT2 signal is fixed to a Low state (at time t2). As the DOUT2 signal becomes fixed to the Low state, the reset states of the F/Fs 82 and 83 in FIG. 17 are cancelled. Thereby, the F/F 82 latches the Chargec signal at a rising edge of the TEST signal, and the STOP2 signal becomes High (at time t2). Thus, the PLAYE signal becomes High, and the charging of the DC blocking capacitor C is completed. After that, at time t3, playback of the next musical number starts.

In this way, according to the third embodiment, the mute period is provided at switching of musical numbers. Each of the first and the second selecting circuits 6a and 6b performs the signal propagation determining process by selecting a specific divided voltage based on the information stored in the memory circuit 8, upon which charging/discharging of the DC blocking capacitor C is carried out until the voltage Vc at one end side of the DC blocking capacitor C becomes the voltage Vcx. Therefore, prior to playback of the next musical number, it is possible to set the voltage Vc at one end side of the DC blocking capacitor C to be the voltage Vcx, whereby occurrence of a pop noise can be reliably prevented.

Although the mute circuit in FIG. 13 as described above does not have the fast-charge circuit 41 and the charge controlling circuit 42 in FIG. 9, it is possible to add those circuits to the mute circuit. Thereby, high-speed charging is possible when charging of the DC blocking capacitor C at switching of musical numbers is necessary, and the mute period can be shortened. Moreover, it is also possible to provide both of a fast-discharge circuit and a discharge controlling circuit in the mute circuit.

It is to be understood that aspects of the present invention are not limited to each of the above-described embodiments, while additional advantages and various variants of the present invention are conceivable by one skilled in the art based on the description given above. Various supplementations, modifications and partial eliminations are available within the spirit and scope of the invention as defined in the appended claims and as can be derived from the equivalents of what is defined in the claims.

1. A mute circuit comprising:
a resistor net configured to include a plurality of resistors connected in cascade between two reference voltage terminals, the resistor net being capable of outputting one of divided voltages from between the adjacent resistors;
a selecting circuit configured to control selection of the divided voltage outputted from the resistor net based on logic of a selecting signal;
a signal propagation determining circuit configured to monitor a voltage level of the divided voltage selected by the selecting circuit using an alternating test signal, and determine whether a signal indicating the monitored result propagates or not at the same cycle as that of the test signal;
a memory circuit configured to store data corresponding to an output signal of the signal propagation determining circuit in association with the selecting signal;
a first switching circuit configured to switch whether a DC blocking capacitor is charged or not according to the divided voltage outputted from between specific resistors in the resistor net;
a second switching circuit configured to switch whether different reference voltages or the same reference voltages is applied to the two reference voltage terminals; and
a switch controlling circuit configured to shut off a charge path to the DC blocking capacitor until a result of determination by the signal propagation determining circuit is obtained, select the divided voltage by the selecting circuit based on the data stored in the memory circuit and charge the DC blocking capacitor by switching the first switching circuit after the result of determination by the signal propagation determining circuit has been obtained, and stop charging the DC blocking capacitor by switching the first switching circuit after the output signal of the signal propagation determining circuit becomes steady.

2. The mute circuit according to claim 1, further comprising:
a decoding circuit configured to generate a decoding signal used on a purpose that the selecting circuit select the divided voltage according to specific data stored in the memory circuit, wherein
the switch controlling circuit, until a result of determination by the signal propagation determining circuit is obtained, shuts off a charge path to the DC blocking capacitor by switching the first switching circuit so that the DC blocking capacitor is not charged, and supplies the selecting circuit with the selecting signals with different logics in sequence so that the resistor net outputs the divided signals different from each other in sequence, and the signal propagation determining circuit performs determination process based on the divided voltages,
the switch controlling circuit, after the result of determination by the signal propagation determining circuit is obtained, charges the DC blocking capacitor by switching the first switching circuit, supplies the selecting circuit with the decoding signal, and stands by until the output signal of the signal propagation determining circuit becomes steady, and
the switch controlling circuit, after the output signal of the signal propagation determining circuit becomes steady, switches the first switching circuit in order to stop charging the DC blocking capacitor.

3. The mute circuit according to claim 1, wherein
the resistor net includes first and second resistor strings which are connected between the two reference voltage terminals in series, each of the first and the second resistor strings having a plurality of resistors connected in cascade, and
the first switching circuit switches whether or not one end of the DC blocking capacitor is applied with a voltage at a connection node between the first resistor string and the second resistor string.

4. The mute circuit according to claim 3, wherein
the selecting circuit controls the selection of one among the divided voltages outputted from the first and the second resistor strings according to the logic of the selecting signal.

5. The mute circuit according to claim 1, wherein
the signal propagation determining circuit generates a signal of one bit indicating the monitored result with respect to each of the divided voltages selected by the selecting circuit.

6. The mute circuit according to claim 5, wherein
the memory circuit generates data of one bit with respect to each of the divided voltages selected by the selecting circuit, and stores data with the number of bits as many as the total number of the divided voltages.

7. The mute circuit according to claim 2, wherein
the decoding circuit generates the decoding signal for selecting the selecting signal in a case where the output signal of the signal propagation determining circuit becomes a specific signal.

8. The mute circuit according to claim 7, wherein
the decoding circuit sets a signal at a point of time when logic of a signal outputted from the signal propagation determining circuit starts changing, or a signal at a point of time when logic of a signal outputted from the signal propagation determining circuit stops changing, as the specific signal.

9. The mute circuit according to claim 7, further comprising:
a charge stop signal generator configured to generate a charge stop signal when the output signal of the signal propagation determining circuit becomes the specific signal while the signal propagation determining circuit performs the determining process based on the decoding signal, wherein
the switch controlling circuit stops charging the DC blocking capacitor by switching the first switching circuit in a case where the charge stop signal is generated.

10. The mute circuit according to claim 1, wherein
the signal propagation determining circuit has a first transistor of a first conductive type, a second transistor of a first conductive type, a third transistor of a second conductive type, and a fourth transistor of a second conductive type, which are connected in cascade between the two reference voltage terminals,
the test signal is inputted to a gate of each of the first transistor and the fourth transistor,
the divided voltage selected by the selecting circuit is inputted to a gate of each of the second transistor and the third transistor, and
a signal indicating the monitored result is outputted from a connection node at an output side of the second and the third transistors.

11. The mute circuit according to claim 2, wherein:
the resistor net includes first and second resistor strings connected in series between the two reference voltage terminals, each of the first and the second resistor strings having a plurality of resistors connected in cascade;
the selecting circuit includes
a first selector configured to control selection of a first divided voltage to be outputted from the first resistor string according to logic of a first selecting signal, and
a second selector configured to control selection of a second divided voltage to be outputted from the second resistor string according to logic of a second selecting signal;
the signal propagation determining circuit includes
a first signal propagation determiner configured to monitor a voltage level of the divided voltage selected by the first selector using the test signal, and determine whether a signal indicating the monitored result that has the same cycle as the test signal propagates or not, and
a second signal propagation determiner configured to monitor a voltage level of the divided voltage selected by the second selector using the test signal, and determine whether a signal indicating the monitored result that has the same cycle as the test signal propagates or not;
the memory circuit includes
a first memory part configured to store data corresponding to an output signal of the first signal propagation determiner in association with the first selecting signal, and
a second memory part configured to store data corresponding to an output signal of the second signal propagation determiner in association with the second selecting signal; and
the decoding circuit includes
a first decoder configured to generate a first decoding signal so that the first selector selects a divided voltage according to the data stored in the first memory part, and
a second decoder configured to generate a second decoding signal so that the second selector selects a divided voltage according to the data stored in the second memory part.

12. The mute circuit according to claim 11, wherein
a determining process by the first signal propagation determiner and a determining process by the second signal propagation determiner are performed in parallel with each other.

13. The mute circuit according to claim 11, further comprising:
a first charge stop signal generator configured to generate a first charge stop signal when the output signal of the first signal propagation determiner becomes a first specific signal while the first signal propagation determiner performs a determining process based on the first decoding signal; and
a second charge stop signal generator configured to generate a second charge stop signal when the output signal of the second signal propagation determiner becomes a second specific signal while the second signal propagation determiner performs a determining process based on the second decoding signal, wherein
the switch controlling circuit switches the first switching circuit based on logics of the first and the second charge stop signals.

14. The mute circuit according to claim 13, further comprising:
a fast-charge circuit configured to switch a charging speed with respect to the DC blocking capacitor in a stepwise manner based on the logics of the first and the second charge stop signals.

15. The mute circuit according to claim 11, further comprising:
a playback end voltage determining circuit configured to determine whether a voltage at one end side of the DC blocking capacitor is higher than a predetermined reference voltage or not at a point of time when one music playback is completed, wherein
when the playback end voltage determining circuit determines that the voltage at one end side of the DC blocking capacitor is higher than the predetermined reference voltage, the first and the second selectors select divided voltages according to the data stored in the first and the second memory parts,
when the playback end voltage determining circuit determines that the voltage at one end side of the DC blocking capacitor is higher than the predetermined reference voltage, the switch controlling circuit switches the first switching circuit so that the DC blocking capacitor is discharged until the output signals of the first and the second signal propagation determiners become steady, and
when the playback end voltage determining circuit determines that the voltage at one end side of the DC blocking capacitor is lower than the predetermined reference voltage, the switch controlling circuit switches the first switching circuit so that the DC blocking capacitor is charged until the output signals of the first and the second signal propagation determiners become steady.

16. The mute circuit according to claim 15, wherein
the switch controlling circuit switches the first switching circuit after the end of one music playback, so that the voltage at one end side of the DC blocking capacitor becomes the reference voltage and the next music playback starts after that.

17. The mute circuit according to claim 15, wherein;
the playback end voltage determining circuit includes
a first playback end voltage determiner configured to determine whether a voltage at one end side of the DC blocking capacitor is higher than a predetermined reference voltage or not based on the output signal of the first signal propagation determiner, and
a second playback end voltage determiner configured to determine whether a voltage at one end side of the DC blocking capacitor is higher than a predetermined reference voltage or not based on the output signal of the second signal propagation determiner, and
the switch controlling circuit switches the first switching circuit based on results of determination by the first and the second playback end voltage determiners.

18. The mute circuit according to claim 1, wherein
the switch controlling circuit performs a determining process by the signal propagation determining circuit and a charge control of the DC blocking capacitor by the switch controlling circuit at every power activation.

19. The mute circuit according to claim 1, further comprising:
a fast-charge circuit configured to increase a charging speed of the DC blocking capacitor in a stepwise manner.

20. The mute circuit according to claim 19, wherein
the fast-charge circuit increases a charging speed of the DC blocking capacitor at an initial charging of the DC blocking capacitor.
